(19) United States
(12) Patent Application Publication
(10) Pub. No.: US 2024/0295793 A1
(43) Pub. Date: Sep. 5, 2024

(54) SPECKLE MITIGATION DEVICES INCLUDING DYNAMIC MICROSTRUCTURAL MATERIALS

(71) Applicant: Meta Platforms Technologies, LLC, Menlo Park, CA (US)

(72) Inventors: Spencer Allan Wells, Seattle, WA (US); Kenneth Alexander Diest, Kirkland, WA (US)

(21) Appl. No.: 18/595,412

(22) Filed: Mar. 4, 2024

Related U.S. Application Data
(60) Provisional application No. 63/488,252, filed on Mar. 3, 2023.

(51) Int. Cl. G02F 1/355; G02F 1/00; G02F 1/03; G02F 1/035

(52) U.S. Cl. CPC G02F 1/3558; G02F 1/0027; G02F 1/0316; G02F 1/035

(57) ABSTRACT

A device includes a pair of electrodes and a dynamic material disposed between the pair of electrodes, the dynamic material including a crystalline microstructure configured to change between at least two states in response to a change in an electric field between the two electrodes. A material includes tetragonal lead magnesium niobate-lead titanate (PMN-PT) and at least one lanthanide series element. A method includes doping a lead magnesium niobate-lead titanate material with at least one lanthanide series element, and processing the PMN-PT material to form tetragonal PMN-PT. A further method includes forming a low refractive index nanostructured grating over a carrier substrate, forming a high refractive index layer over the low refractive index grating to produce a nanostructured coupling element, forming an adhesive layer over the nanostructured coupling element, and affixing the nanostructured coupling element to a high index waveguide.

### CROSS-REFERENCE TO RELATED APPLICATIONS

This application claims the benefit of priority under 35 U.S.C. § 119(e) of U.S. Provisional Application No. 63/488,252, filed Mar. 3, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1A illustrates an example speckle mitigation device in a first state in accordance with some embodiments.

FIG. 1B illustrates the example speckle mitigation device of FIG. 1A in a second state in accordance with some embodiments.

FIG. 2A illustrates an example speckle mitigation device in a first state in accordance with some embodiments.

FIG. 2B illustrates the example speckle mitigation device of FIG. 2A in a second state in accordance with some embodiments.

FIG. 3A illustrates an example speckle mitigation device in a first state in accordance with some embodiments.

FIG. 3B illustrates the example speckle mitigation device of FIG. 2A in a second state in accordance with some embodiments.

FIG. 4A illustrates an example speckle mitigation device in a first state in accordance with some embodiments.

FIG. 4B illustrates the example speckle mitigation device of FIG. 2A in a second state in accordance with some embodiments.

FIG. 5A illustrates domain polarization directions for an example phase of a piezoelectric material.

FIG. 5B illustrates domain polarization directions for an example phase of a piezoelectric material.

FIG. 6 is a flow diagram of an exemplary method for operating a speckle mitigation system, in accordance with some embodiments.

FIG. 7 is an illustration of exemplary augmented-reality glasses that may be used in connection with embodiments of this disclosure.

FIG. 8 is an illustration of an exemplary virtual-reality headset that may be used in connection with embodiments of this disclosure.

FIG. 9 is an illustration of exemplary haptic devices that may be used in connection with embodiments of this disclosure.

FIG. 10 is an illustration of an exemplary virtual-reality environment according to embodiments of this disclosure.

FIG. 11 is an illustration of an exemplary augmented-reality environment according to embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Laser speckle is a fundamental issue with conventional laser illuminated displays and other systems utilizing coherent light sources. Speckle mitigation approaches have focused on mechanical motion/translation of either particles or hazy surfaces or by using patterned gratings. Some examples of speckle mitigation systems include physically vibrating a piece of ground glass, mechanically moving diffusers, rapidly pulsing a laser, and/or using pre-patterned switchable LC gratings. Unfortunately, mechanical approaches are typically difficult to integrate robustly in commercially-relevant systems. Additionally, creating intentional gratings can send a large fraction of light in directions other than the intended display direction.

The present disclosure is generally directed to several approaches to speckle reduction, including: 1) electrically changing the magnitude of optical scatter in a material, 2) thermally changing the magnitude of optical scatter in a material, 3) electrically changing the distribution of optical scatter in a material, 4) thermally changing the distribution of optical scatter in a material, combining both thermal and electrical impulses to change the magnitude of optical scatter in a material, and/or 5) combining both thermal and electrical impulses to change the distribution of optical scatter in a material. As described herein, electric field and material switching may happen quickly enough that a speckle pattern becomes imperceptible.

Various crystalline microstructures may provide desired levels of speckle reduction. One example system may utilize multidomain ferroelectric materials that undergo a phase transformation to a single domain. Additionally or alternatively, an example system may utilize multidomain ferroelectrics that rearrange their microstructure. In this example, the domain size and magnitude of a refractive index difference between different states may change with electric field. Some example systems may utilize electrostrictive ceramics or crystalline materials that undergo a phase transformation to multidomain ferroelectrics.

In some examples, dynamic haze may be generated in a material having pre-existing bulk haze. This is a non-mechanical solution that doesn't require sophisticated high frequency electronics applicability in augmented reality, virtual reality, and/or other applications utilizing laser light sources. Any suitable material may be used, including, for example, a ferroelectric or electrostrictive material (e.g., a ceramic, crystalline, or polycrystalline composition). In at least one example, a multidomain material, such as a ferroelectric material, may be disposed between a pair of electrodes that alternatively vary an electric field applied to the material.

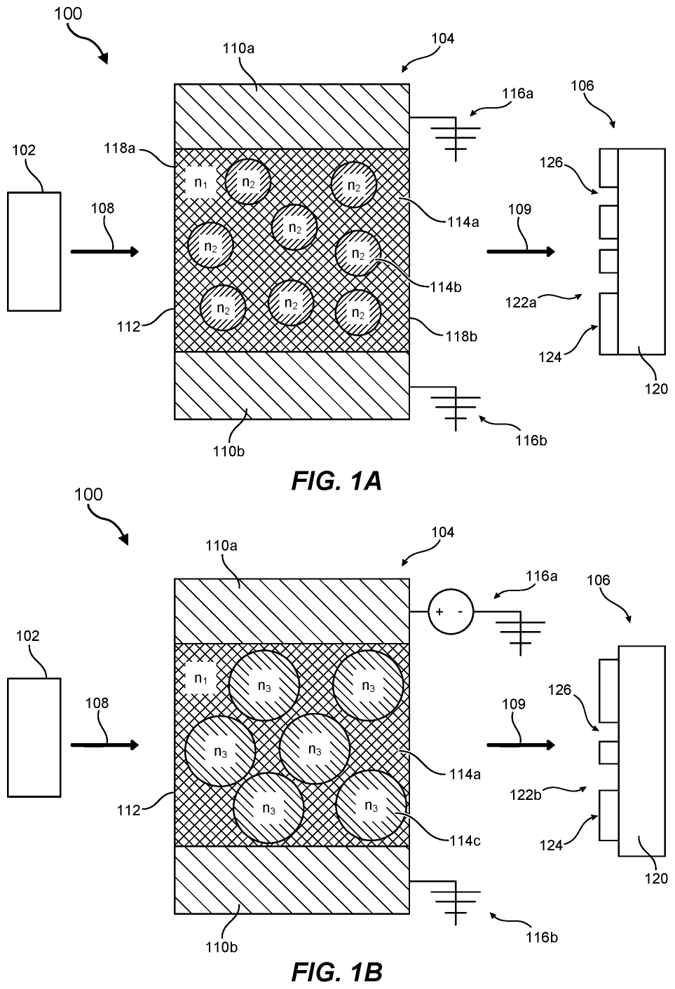

FIGS. 1A and 1B show at least a portion of a display system 100 that includes a speckle mitigation device 104 that receives light 108 emitted from a light source 102. Light source 102 may be any suitable light emitting device, such as a laser source that emits coherent light 108, such as a coherent light beam. Light 108 received by speckle mitigation device 104 may pass through a dynamic material 112 of speckle mitigation device 104 and be emitted as light 109. Emitted light 109 may be directed toward additional components of display system 100. A screen 106 is shown in the illustrated embodiments to illustrate effects of speckle mitigation evident in the emitted light 109 due to changes in speckle mitigation device 104. Light 109 emitted from speckle mitigation device 104 may alternatively or additionally pass through any other suitable components of a display system (e.g., a lens, a collimator, a waveguide, a light modulation panel, and/or any other suitable display components).

FIGS. 1A and 1B show a first electrode 110a and a second electrode 110b arranged so that light passing through dynamic material 112 does not pass through first and second electrodes 110a and 110b to a substantial extent. For example, first electrode 110a and/or a second electrode 110b may extend along surfaces of dynamic material 112 that are generally parallel to a path of light 108. Accordingly, light 108 may pass through dynamic material 112 without substantially impacting or passing through either of first and second electrodes 110a and 110b. In some examples, first electrode 110a and/or second electrode 110b may include an opaque material. In at least one embodiment, first electrode 110a and/or second electrode 110b may include a reflective surface that reflects incident light toward dynamic material 112. In at least one example, dynamic material 112 may be utilized as a waveguide, and in some examples, relatively low voltages may be applied to operate such a waveguide.

First electrode 110a may be electrically coupled to a first voltage source 116a and second electrode 110b may be electrically coupled to a second voltage source or ground 116b. As such, any suitable electrically conductive material, including opaque or other partially or substantially non-transparent materials, may be used for first electrode and/or second electrode 110b. In some examples, first and second electrodes 110a and 110b may each include metals such as aluminum, gold, silver, tin, copper, indium, gallium, zinc, and the like. Other conductive materials may be used, including carbon nanotubes, graphene, silver nanowires, transparent conductive oxides (TCOs, such as indium tin oxide (ITO), zinc oxide (ZnO), etc.), and the like. In some embodiments, an antireflective (AR) coating may be disposed on a light incident surface 118a (i.e., surface that receives light 108) and/or a light exit surface 118b (i.e., surface from which light 109 is emitted) of dynamic material 112 so that little or no light is reflected when entering and/or exiting speckle mitigation device 104.

As shown in FIG. 1A, when speckle mitigation device 104 is in a first voltage state (e.g., when 0 V or relatively low voltage differential is applied between first and second electrodes 110a and 110b), the dynamic material 112 may be in a first state. As shown in FIG. 1B, when speckle mitigation device 104 is in a second voltage state, (e.g., when a non-zero voltage differential or a different voltage differential, such as a higher voltage, is applied between first and second electrodes 110a and 110b), the dynamic material 112 may be in a second state. The light 108 (e.g., coherent laser light) may produce different speckle patterns when passing through dynamic material 112 in each of the first and second voltage states.

By dynamically causing dynamic material 112 to alternate between the first and second states, the visual speckle pattern may be mitigated by directing the light in different directions in each of the first state and second state (e.g., via optical refraction, diffraction, scattering, etc.). For example, FIGS. 1A and 1B illustrate the different patterns of light emitted from speckle mitigation device 104 in each of the first and second states. As shown, example screen 106, which is presented for purposes of illustration, includes a screen surface 120 on which light 109 emitted from speckle mitigation device 104 is incident, forming a first light pattern 122a in the first state (FIG. 1A) and a second light pattern 122b in the second state (FIG. 1B). The first and second light patterns 122a and 122b may include illuminated regions 124, where light 109 reaches screen surface 120, and speckle regions 126, where light 109 does not reach screen surface 120. As shown, first and second light patterns 122a and 122b may have different distributions and locations of illuminated regions 124 and speckle regions 126 due to differences in light scattering in each of the first and second states. When speckle mitigation device 104 is switched between the first and second states at a sufficient rate, light passing through speckle mitigation device 104 may appear to substantially or completely cover a homogenous lighted region of screen surface 120 when viewed by the human eye. Accordingly, the appearance of speckle regions in the lighted region may be minimized or eliminated.

Dynamic material 112 may include any suitable material that undergoes a change that causes differences in light scattering and/or refraction (e.g., different light scattering patterns, different refractive index magnitudes in various regions, etc.) when different electric fields are applied to dynamic material 112. For example, dynamic material 112 may include one or more materials that undergo a phase change and/or microstructural rearrangement when an electric field applied between first and second electrodes 110a and 110b is changed. In one example, dynamic material 112 may include a multidomain ferroelectric material that undergoes a microstructural rearrangement such that the crystalline microstructures of dynamic material 112 is different in each of the first and second states, as illustrated in FIGS. 1A and 1B. In the example shown in these figures, dynamic material 112 includes, in the first state of FIG. 1A, a multidomain material having a first crystalline microstructure that includes a first domain n₁ and a second domain n₂. As illustrated, for example, first domain n₁ may occupy a bulk of dynamic material 112 and a plurality of smaller second domains n₂ (i.e., domains occupying relatively smaller regions) distributed within dynamic material 112.

In the second state of FIG. 1B, dynamic material 112 may have a second crystalline microstructure that includes, for example first domain n₁ and second domains n₂. For example, at least a portion of second domains n₂ and/or first domain n₁ may be transformed (e.g., via domain nucleation, etc.) to a third domains n₃ such that a plurality of n₃ domains are distributed within dynamic material 112, either alone (as illustrated in FIG. 1B) or in combination with n₂ domains. The n₁ domain may occupy the bulk of dynamic material 112 in FIG. 1B. The n₃ domain of FIG. 1B may be different from the n₂ domains of FIG. 1A in one or more respects. For example, the n₃ domains may have a different size, shape, refractive index, and/or any other suitable difference from the n₂ domains such that the pattern of light 109 emitted from dynamic material 112 differs between the first state of FIG. 1A and the second state of FIG. 1B.

The electric field applied between first and second electrodes 110a and 110b may be switched by changing the voltages of first electrode 110a and/or second electrode 110b multiple times so to alternate the state of speckle mitigation device 104 between two or more states (e.g., the first and second states illustrated in FIGS. 1A and 1B) at a selected frequency to minimize or eliminate negative visible effects of speckle of light emitted from the light source 102. Switching frequencies may, for example, be greater than 100 Hz (e.g., approximately 100 Hz, approximately 200 Hz, approximately 300 Hz, approximately 400 Hz, approximately 500 Hz, approximately 600 Hz, approximately 700 Hz, approximately 800 Hz, approximately 900 Hz, approximately 1000 Hz).

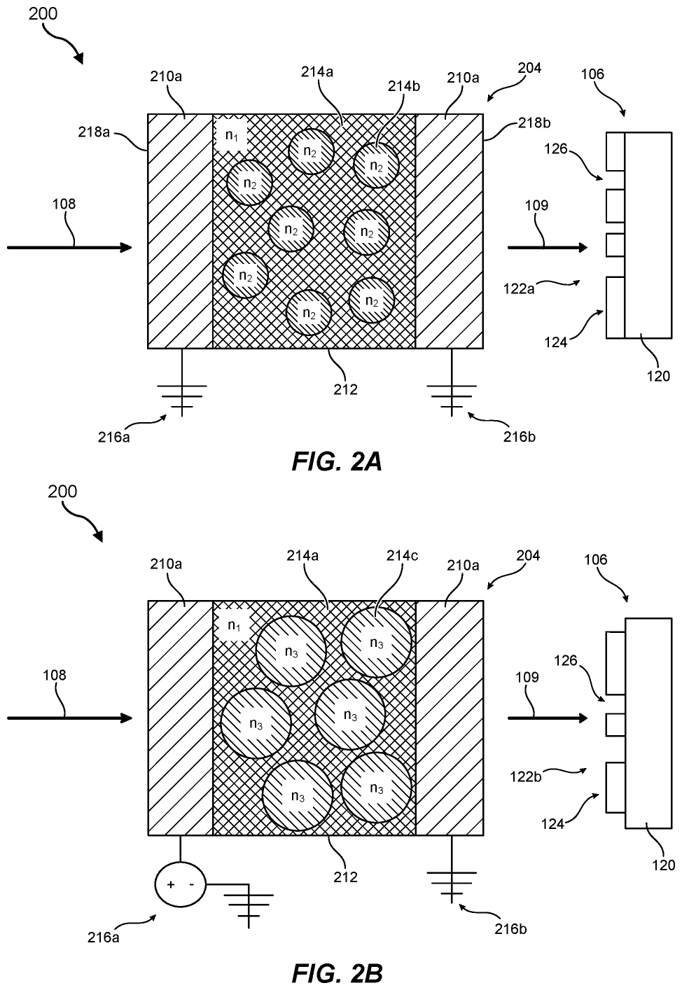

FIGS. 2A and 2B illustrate at least a portion of a display system 200 that includes a speckle mitigation device 204 that receives light 108 emitted from a light source (e.g., light source 102 in FIGS. 1A and 1B). Light 108 received by speckle mitigation device 204 may pass through a dynamic material 212 of speckle mitigation device 204 and be emitted as light 109. Emitted light 109 may be directed toward additional components of display system 100, such as example screen 106 shown in FIGS. 2A and 2B.

Display system 200 illustrated in FIGS. 2A and 2B differs, at least in part, from display system 100 in FIGS. 1A and 1B in the positions and orientations of first and second electrodes 210a and 210b with respect to a path of light 108 incident on speckle mitigation device 204 and light 109 emitted from speckle mitigation device 204. For example, first and second electrodes 210a and 210b may be oriented such that light 108 may pass through first electrode 210a and second electrode 210b, which are arranged transversely with respect to light 108. As illustrated, for example, first electrode 210a and second electrode 210b may be disposed along surfaces of speckle mitigation device 204 that receive light 108 and emit light 109 from speckle mitigation device 204. As such, first and second electrodes 210a and 210b may each include a partially or substantially transparent material, such as a TCO (e.g., ITO, ZnO, etc.) that is electrically conductive while allowing for passage of light. In some embodiments, an AR coating may be disposed on a light incident surface 218a of first electrode 210a and/or a light exit surface 218b of second electrode 210b so that little or no light is reflected. First electrode 210a may be electrically coupled to a first voltage source 216a and second electrode 210b may be electrically coupled to a second voltage source or ground 216b.

As shown in FIG. 2A, when speckle mitigation device 204 is in a first voltage state (e.g., when 0 V or relatively low voltage differential is applied between first and second electrodes 210a and 210b), the dynamic material 212 may be in a first state. As shown in FIG. 2B, when speckle mitigation device 204 is in a second voltage state, (e.g., when a non-zero voltage differential or a different voltage differential, such as a higher voltage, is applied between first and second electrodes 210a and 210b), the dynamic material 212 may be in a second state. The light 108 may produce different speckle patterns when passing through dynamic material 212 in each of the first and second voltage states. By dynamically causing dynamic material 212 to alternate between the first and second states, the visual speckle pattern may be mitigated by directing the light in different directions in each of the first state and second state (e.g., via optical refraction, diffraction, scattering, etc.).

Dynamic material 212 may include any suitable material that undergoes a change that causes differences in light scattering and/or refraction in accordance with any of the embodiments described herein. For example, dynamic material 212 may include one or more materials that undergo a phase change and/or microstructural rearrangement when an electric field applied between first and second electrodes 210a and 210b is changed. In the example shown, dynamic material 212 may include, in the first state of FIG. 2A, a multidomain material having a first domain n₁ and a second domain n₂. In the second state of FIG. 2B, at least a portion of second domain n₂ and/or first domain n₁ may be transformed to a third domain ng such that a plurality of n₃ domains are distributed within dynamic material 212. The n₃ domains may have a different size, shape, refractive index, and/or any other suitable difference from the n₂ domains such that the pattern of light 109 emitted from dynamic material 212 differs between the first state of FIG. 2A and the second state of FIG. 2B.

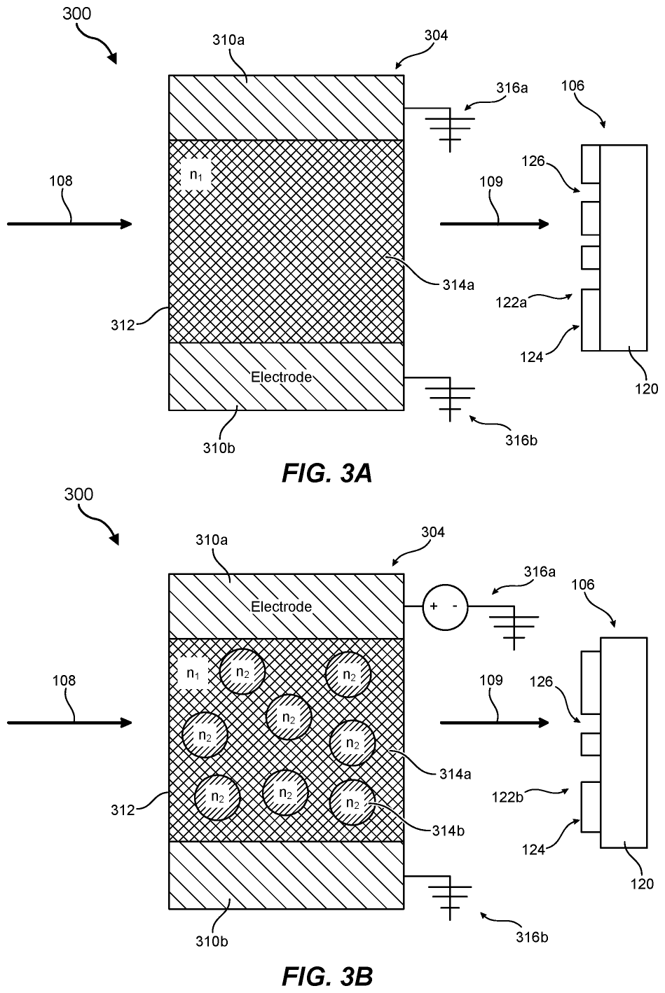

FIGS. 3A and 3B illustrate at least a portion of a display system 300 that includes a speckle mitigation device 304 that receives light 108 emitted from a light source (e.g., light source 102 in FIGS. 1A and 1B). Light 108 received by speckle mitigation device 304 may pass through a dynamic material 312 of speckle mitigation device 304 and be emitted as light 109, which may be directed toward additional components of display system 100, such as example screen 106 shown in FIGS. 3A and 3B.

Display system 300 illustrated in FIGS. 3A and 3B includes first and second electrodes 310a and 310b that may be disposed in any suitable positions and orientation with respect to a path of light 108 incident on speckle mitigation device 304 and light 109 emitted from speckle mitigation device 304 (see, e.g., FIGS. 1A-2B). In at least one embodiment, first electrode 310a and second electrode 310b may be arranged so that light passing through dynamic material 312 does not pass through first and second electrodes 310a and 310b to a substantial extent (e.g., first electrode 310a and/or a second electrode 310b may extend along surfaces of dynamic material 312 that are generally parallel to a path of light 108, as shown in FIGS. 3A and 3B). In an additional embodiment, first and second electrodes 310a and 310b may be oriented such that light 108 passes through first electrode 310a and second electrode 310b (e.g., first and second electrodes 310a and 310b may be arranged transversely with respect to light 108, as shown in FIGS. 2A and 2B). First electrode 310a may be electrically coupled to a first voltage source 316a and second electrode 310b may be electrically coupled to a second voltage source or ground 316b. In some examples, AR coatings may be disposed on a light incident and/or exit surface of speckle mitigation device 304 in accordance with other embodiments described herein (see, e.g., FIGS. 1A-2B).

As shown in FIG. 3A, when speckle mitigation device 304 is in a first voltage state (e.g., when 0 V or relatively low voltage differential is applied between first and second electrodes 310a and 310b), the dynamic material 312 may be in a first state. As shown in FIG. 3B, when speckle mitigation device 304 is in a second voltage state, (e.g., when a non-zero voltage differential or a different voltage differential, such as a higher voltage, is applied between first and second electrodes 310a and 310b), the dynamic material 312 may be in a second state. The light 108 may produce different speckle patterns when passing through dynamic material 312 in each of the first and second states. By dynamically causing dynamic material 312 to alternate between the first and second states, the visual speckle pattern may be mitigated by directing the light in different directions in each of the first state and second state (e.g., via optical refraction, diffraction, scattering, etc.).

Dynamic material 312 may include any suitable material that undergoes a change that causes differences in light scattering and/or refraction in accordance with any of the embodiments described herein. For example, dynamic material 312 may include one or more materials that undergo a phase change and/or microstructural rearrangement when an electric field applied between first and second electrodes 310a and 310b is changed. In one example, dynamic material 312 may include an electrostrictive material (e.g., an electrostrictive ceramic or crystal) that undergoes a phase transformation such that at least a portion of the microstructure of dynamic material 312 is different in each of the first and second states, as illustrated in FIGS. 3A and 3B. In the example shown in these figures, dynamic material 312 includes, in the first state of FIG. 3A, a single domain or substantially single domain material having a first domain n₁. As illustrated, for example, first domain n₁ may occupy a bulk of dynamic material 312.

In the second state of FIG. 3B, dynamic material 312 may be transformed (e.g., via domain nucleation), in the presence of the applied electric field, to a multidomain material, such as a multidomain ferroelectric. The multidomain dynamic material shown in FIG. 3B may include, for example, a plurality of second domains n₂ distributed within dynamic material 312. In at least one examples, the n₁ domain may occupy the bulk of dynamic material 312, as shown in FIG. 3B. The n₂ domains of FIG. 3B may different from the n₁ domain in one or more respects. For example, the n₂ domains may have a different size, shape, refractive index, and/or any other suitable difference from the n₁ domain such that the pattern of light 109 emitted from dynamic material 312 differs between the first state of FIG. 3A and the second state of FIG. 3B.

In at least one embodiment, dynamic material 312 may include a single-crystal, substantially single-crystal, and/or preferentially-oriented electrostrictive material (e.g., n₁ domain crystal), such as an electrostrictive ceramic, in the first state. The electrostrictive material can be a single-domain cubic material in the absence of an applied electric field (see FIG. 3A) such that dynamic material 312 doesn't scatter light to a substantial extent. Subsequently, under an applied electric field (see FIG. 3B), the electrostrictive material of dynamic material 312 can transform into a low symmetry multidomain material having a plurality of domains (e.g., n₂ domains) throughout.

According to some embodiments, dynamic material 312 may include a lead magnesium niobate-lead titanate (PMN-PT) material in a single-crystal, substantially single-crystal, and/or preferentially-oriented configuration. According to one example, in the first state during which substantially no electric field is applied, the PMN-PT domain(s) of dynamic material 312 may be in a low temperature tetragonal phase. The tetragonal phase PMN-PT material may be oriented with respect to first and second electrodes 310a and 310b so that the tetragonal phase PMN-PT material polarizes into multiple domains. For example, the tetragonal phase PMN-PT material may be oriented, while in the first state (FIG. 3A), so that an electric field subsequently generated between first and second electrodes 310a and 310b is applied to the tetragonal phase PMN-PT material along the <111>, <110>, or low symmetry orientation, causing the PMN-PT material to polarize into multiple domains in the second state (FIG. 3B).

According to an additional example, in the first state during which substantially no electric field is applied, the PMN-PT domain(s) of dynamic material 312 may be in a low temperature rhombohedral phase. The rhombohedral phase PMN-PT material may be oriented with respect to first and second electrodes 310a and 310b so that the rhombohedral phase PMN-PT material polarizes into multiple domains. For example, the rhombohedral phase PMN-PT material may be oriented, while in the first state (FIG. 3A), so that an electric field subsequently generated between first and second electrodes 310a and 310b is applied to the rhombohedral phase PMN-PT material along the <100>, <110>, or low symmetry orientation, causing the PMN-PT material to polarize into multiple domains in the second state (FIG. 3B).

In at least one example, the dynamic material 312 may include a single-crystal, substantially single-crystal, and/or preferentially-oriented polycrystalline electroceramic material, in the first state. The polycrystalline electroceramic material can be a single-domain material in the absence of an applied electric field (see FIG. 3A) such that dynamic material 312 doesn't scatter light to a substantial extent. The polycrystalline electroceramic material may be oriented such that, under an applied electric field (see FIG. 3B), the polycrystalline electroceramic material of dynamic material 312 can transform into a low symmetry multidomain material having a plurality of domains throughout.

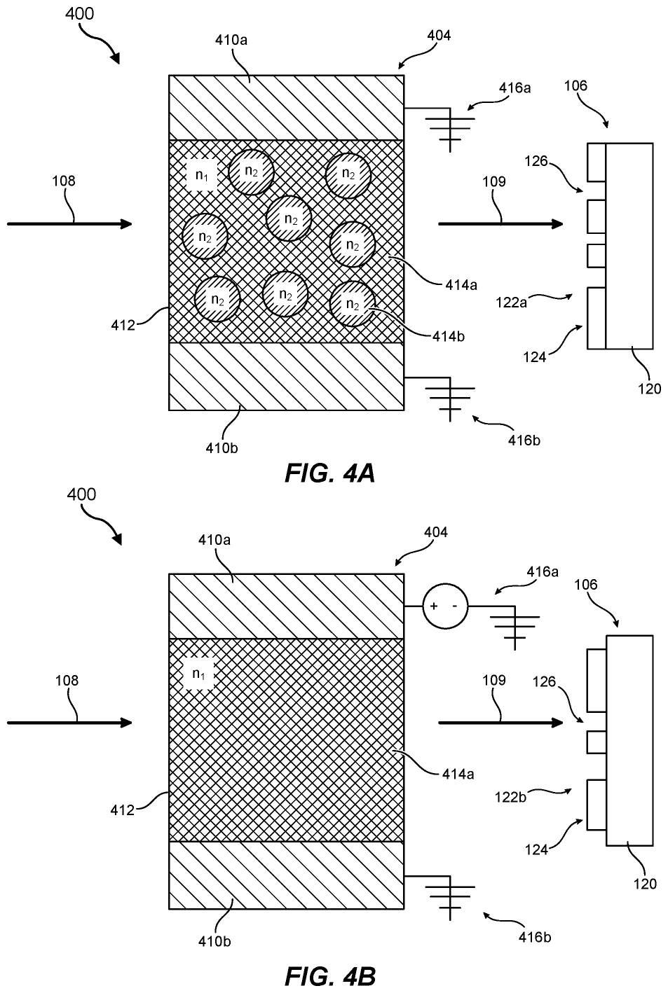

FIGS. 4A and 4B illustrate at least a portion of a display system 400 that includes a speckle mitigation device 404 that receives light 108 emitted from a light source (e.g., light source 102 in FIGS. 1A and 1B). Light 108 received by speckle mitigation device 404 may pass through a dynamic material 412 of speckle mitigation device 404 and be emitted as light 109, which may be directed toward additional components of display system 100, such as example screen 106 shown in FIGS. 4A and 4B.

Display system 400 illustrated in FIGS. 4A and 4B includes first and second electrodes 410a and 410b that may be disposed in any suitable positions and orientation with respect to a path of light 108 incident on speckle mitigation device 404 and light 109 emitted from speckle mitigation device 404 (see, e.g., FIGS. 1A-2B). In at least one embodiment, first electrode 410a and second electrode 410b may be arranged so that light passing through dynamic material 412 does not pass through first and second electrodes 410a and 410b to a substantial extent (e.g., first electrode 410a and/or a second electrode 410b may extend along surfaces of dynamic material 412 that are generally parallel to a path of light 108, as shown in FIGS. 4A and 4B). In an additional embodiment, first and second electrodes 410a and 410b may be oriented such that light 108 passes through first electrode 410a and second electrode 410b (e.g., first and second electrodes 410a and 410b may be arranged transversely with respect to light 108, as shown in FIGS. 2A and 2B). First electrode 410a may be electrically coupled to a first voltage source 416a and second electrode 410b may be electrically coupled to a second voltage source or ground 416b. In some examples, AR coatings may be disposed on a light incident and/or exit surface of speckle mitigation device 404 in accordance with other embodiments described herein (see, e.g., FIGS. 1A-2B).

As shown in FIG. 4A, when speckle mitigation device 404 is in a first voltage state (e.g., when 0 V or relatively low voltage differential is applied between first and second electrodes 410a and 410b), the dynamic material 412 may be in a first state. As shown in FIG. 4B, when speckle mitigation device 404 is in a second voltage state, (e.g., when a non-zero voltage differential or a different voltage differential, such as a higher voltage, is applied between first and second electrodes 410a and 410b), the dynamic material 412 may be in a second state. The light 108 may produce different speckle patterns when passing through dynamic material 412 in each of the first and second states. By dynamically causing dynamic material 412 to alternate between the first and second states, the visual speckle pattern may be mitigated by directing the light in different directions in each of the first state and second state (e.g., via optical refraction, diffraction, scattering, etc.).

Dynamic material 412 may include any suitable material that undergoes a change that causes differences in light scattering and/or refraction in accordance with any of the embodiments described herein. For example, dynamic material 412 may include one or more materials that undergo a phase change and/or microstructural rearrangement when an electric field applied between first and second electrodes 410a and 410b is changed. In one example, dynamic material 412 may include a ferroelectric material that undergoes a phase transformation such that at least a portion of the microstructure of dynamic material 412 is different in each of the first and second states, as illustrated in FIGS. 4A and 4B. In the example shown in these figures, dynamic material 412 includes, in the first state of FIG. 4A, a multidomain material having two or more domains, such as a first domain n₁ and a second domain n₂ as shown. In the second state of FIG. 4B, dynamic material 412 may be transformed, in the presence of the applied electric field, to a a single domain or substantially single domain material having represented by the illustrated first domain n₁.

In at least one embodiment, dynamic material 412 may include a multidomain ferroelectric material, such as an a PMNT-PT material (e.g., PMN-30 PT), in the first state, when substantially no electric field is applied (see FIG. 4A). Subsequently, under an applied electric field (see FIG. 4B), the electrostrictive material of dynamic material 412 can transform into a single-crystal, substantially single-crystal, and/or preferentially-oriented electrostrictive material in the second state.

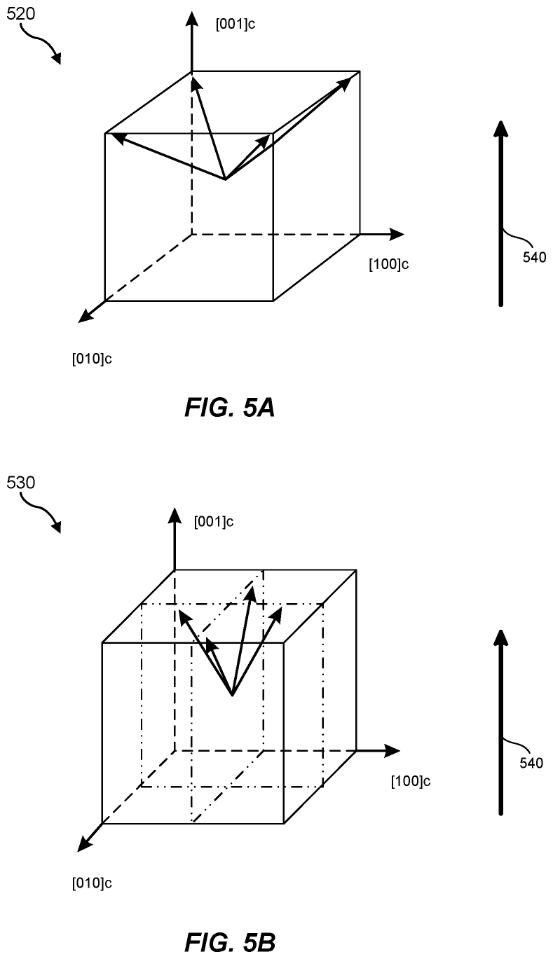

According to one example, in the first state (FIG. 4A) in which substantially no electric field is applied, the multidomain dynamic material 412 may be oriented in relation to first and second electrodes 410a and 410b such that the domains are primarily arranged in a single domain in the second state when an electric field is subsequently applied. In at least one embodiment, dynamic material 412 may include a PMN-PT ferroelectric material that is arranged and oriented such that it assumes a primarily rhombohedral phase in the presence of an electric field (i.e., poling field) between first and second electrodes 410a and 410b. The rhombohedral phase PMNT-PT material may, for example, be oriented with the electric field applied along the <100> orientation in the second phase (FIG. 4B). FIG. 5A illustrates a rhombohedral domain structure 520 of a PMNT-30 PT material. As shown, the tetragonal domain structure 530 is oriented such that an electric field 540, such as that generated between first and second electrodes 410a and 410b, is applied along the <100> orientation.

According to an additional example, dynamic material 412 may include a PMN-PT ferroelectric material that is arranged and oriented such that it assumes a primarily tetragonal phase in the presence of an electric field between first and second electrodes 410a and 410b. The tetragonal phase PMNT-PT material may, for example, be oriented with the electric field applied along the <111> orientation in the second phase (FIG. 4B). FIG. 5B illustrates a tetragonal domain structure 530 of a PMNT-30 PT material. As shown, the tetragonal domain structure 530 is oriented such that electric field 540 is applied along the <111> orientation. In these examples, the multidomain ferroelectric material may be oriented to substantially one domain structure (e.g., rhombohedral or tetragonal) when an electric field is applied between first and second electrodes 410a and 410b.

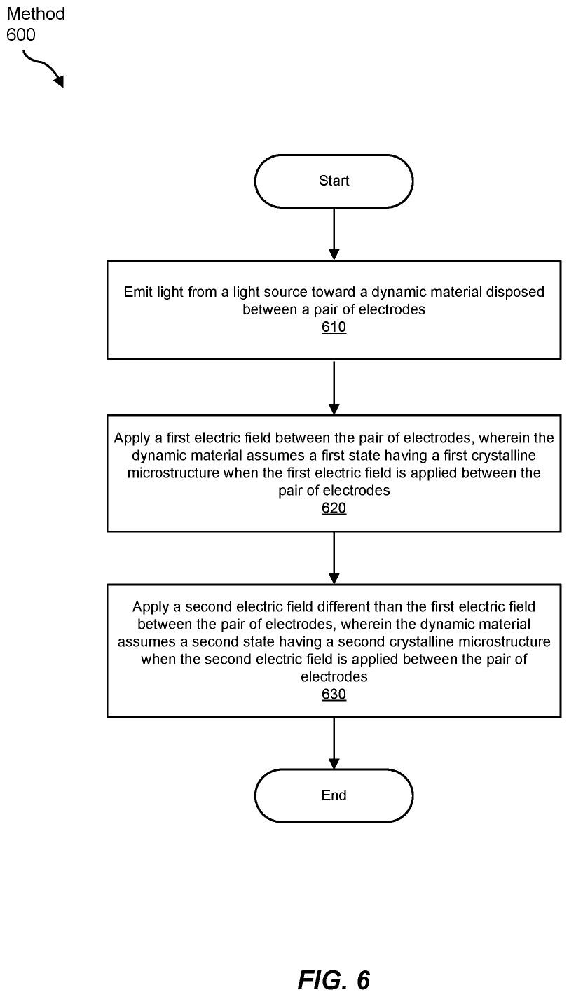

FIG. 6 is a flow diagram of an exemplary method 600 for operating a speckle mitigation system in accordance with embodiments of this disclosure. As illustrated in FIG. 6, at step 610, light may be emitted from a light source toward a dynamic material disposed between a pair of electrodes (see, e.g., FIG. 1A). The light source may include, for example, a coherent light source, such as a laser emitter.

At step 620 in FIG. 6, a first electric field may be applied between the pair of electrodes, wherein the dynamic material assumes a first state having a first crystalline microstructure when the first electric field is applied between the pair of electrodes (see, e.g., FIGS. 1A, 2A, 3A, and 4A).

At step 630 in FIG. 6, a second electric field different than the first electric field may be applied between the pair of electrodes, wherein the dynamic material assumes a second state having a second crystalline microstructure when the second electric field is applied between the pair of electrodes (see, e.g., FIGS. 1B, 2B, 3B, and 4B). The dynamic material may scatter light received from the light source differently in each of the first state and the second state.

In some examples, the first electric field and the second electric field may be alternately applied between the pair of electrodes multiple additional times, wherein the first electric field and the second electric field are alternately applied at a rate of from approximately 100 Hz to approximately 1000 Hz.

### EXAMPLE EMBODIMENTS

Example 1: A device includes a pair of electrodes and a dynamic material disposed between the pair of electrodes, wherein (1) the dynamic material is configured to be in a first state having a first crystalline microstructure when a first electric field is applied between the pair of electrodes, (2) the dynamic material is configured to be in a second state having a second crystalline microstructure when a second electric field different than the first electric field is applied between the pair of electrodes, and (3) the dynamic material is configured to scatter light differently in each of the first state and the second state.

Example 2: The device of Example 1, wherein the dynamic material includes a primarily multidomain material in the first state and the dynamic material includes a primarily single domain material in the second state.

Example 3: The device of Example 1 or 2, wherein the dynamic material includes a ferroelectric material.

Example 4: The device of any of Examples 1-3, wherein the dynamic material includes at least one of an electroceramic material and a polycrystalline ceramic material.

Example 5: The device of any of Examples 1-4, wherein the dynamic material includes lead magnesium niobate-lead titanate (PMN-PT).

Example 6: The device of any of Examples 1-5, wherein the dynamic material includes a multidomain material that is configured to undergo microstructural rearrangement between the first state and the second state.

Example 7: The device of Example 6, wherein the microstructural rearrangement results in a change in domain size of multiple crystalline domains in the dynamic material.

Example 8: The device of any of Examples 1-7, wherein the dynamic material is configured to have a first refractive index in the first state and a second refractive index different than the first refractive index in the second state.

Example 9: The device of any of Examples 1-8, wherein the dynamic material includes an electrostrictive material.

Example 10: The device of Example 9, wherein the electrostrictive material includes a crystalline structure that is oriented to have a polar axis that is substantially parallel to at least one of the first electric field or the second electric field.

Example 11: The device of Example 10, wherein a substantial portion of the electrostrictive material has cubic crystalline structure in at least one of the first state or the second state.

Example 12: The device of Example 10 or 11, wherein the electrostrictive material includes a multidomain material that includes at least one of rhombohedral, monoclinic, or tetragonal domains in at least one of the first state or the second state.

Example 13: The device of any of Examples 10-12, wherein the polar axis is substantially parallel to the at least one of the first electric field or the second electric field when the electrostrictive material is in a low temperature phase.

Example 14: The device of any of Examples 1-13, wherein the electrostrictive material is configured to be transparent when it is in at least one of the first state or the second state.

Example 15: A system includes a light source and a speckle mitigation device including a pair of electrodes and a dynamic material disposed between the pair of electrodes and positioned to receive light emitted from the light source, wherein (1) the dynamic material is configured to be in a first state having a first crystalline microstructure when a first electric field is applied between the pair of electrodes, (2) the dynamic material is configured to be in a second state having a second crystalline microstructure when a second electric field different than the first electric field is applied between the pair of electrodes, and (3) the dynamic material is configured to scatter light received from the light source differently in each of the first state and the second state.

Example 16: The system of Example 15, wherein the light source includes a laser emitter.

Example 17: The system of Example 15 or 16, further including a surface positioned to receive light emitted from the light source and passed through the dynamic material of the speckle mitigation device, wherein the speckle mitigation device is configured to produce a first speckle pattern on the surface when the dynamic material is in the first state, and the speckle mitigation device is configured to produce a second speckle pattern on the surface when the dynamic material is in the second state.

Example 18: A method includes (1) emitting light from a light source toward a dynamic material disposed between a pair of electrodes, (2) applying a first electric field between the pair of electrodes, wherein the dynamic material assumes a first state having a first crystalline microstructure when the first electric field is applied between the pair of electrodes, and (3) applying a second electric field different than the first electric field between the pair of electrodes, wherein the dynamic material assumes a second state having a second crystalline microstructure when the second electric field is applied between the pair of electrodes.

Example 19: The method of Example 18, wherein the dynamic material scatters light received from the light source differently in each of the first state and the second state.

Example 20: The method of Example 18 or 19, further including alternately applying the first electric field and the second electric field between the pair of electrodes multiple additional times, wherein the first electric field and the second electric field are alternately applied at a rate of from approximately 100 Hz to approximately 1000 Hz.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

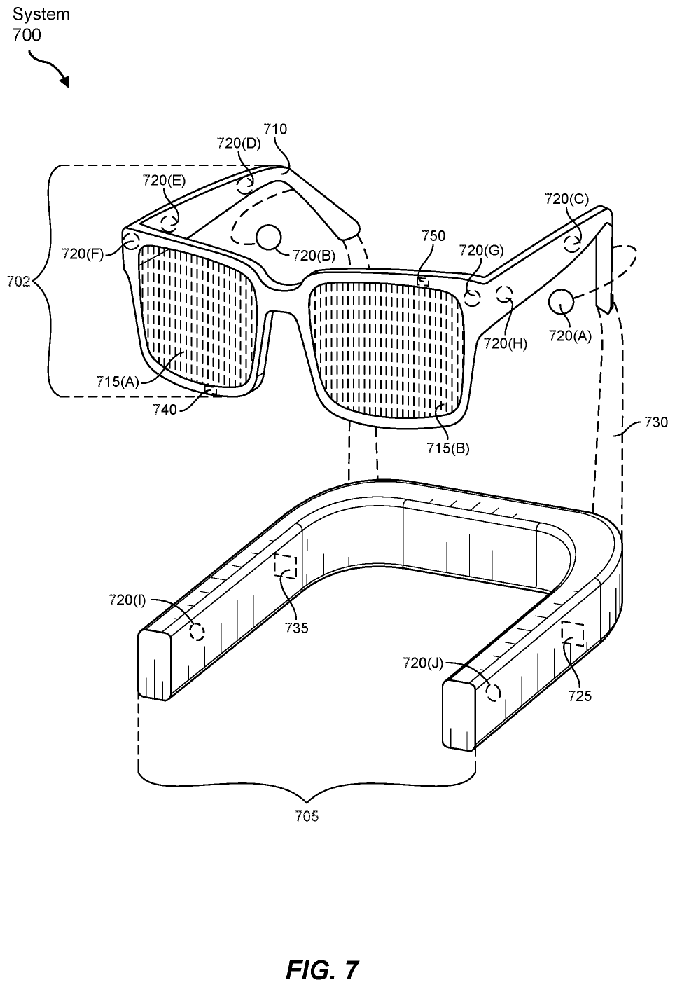

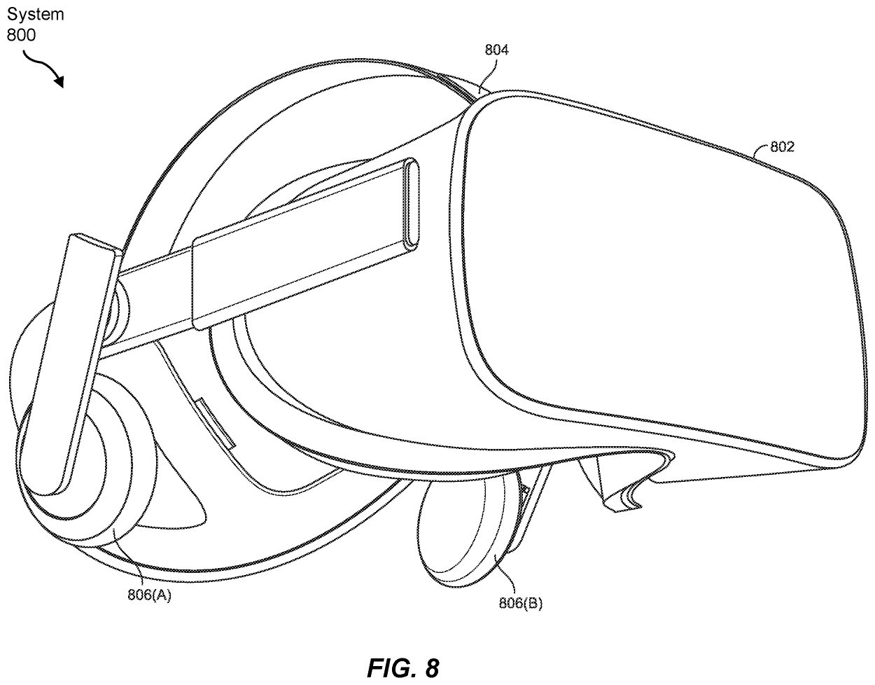

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 700 in FIG. 7) or that visually immerses a user in an artificial reality (such as, e.g., virtual-reality system 800 in FIG. 8). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 7, augmented-reality system 700 may include an eyewear device 702 with a frame 710 configured to hold a left display device 715(A) and a right display device 715(B) in front of a user's eyes. Display devices 715(A) and 715(B) may act together or independently to present an image or series of images to a user. While augmented-reality system 700 includes two displays, embodiments of this disclosure may be implemented in augmented-reality systems with a single NED or more than two NEDs.

In some embodiments, augmented-reality system 700 may include one or more sensors, such as sensor 740. Sensor 740 may generate measurement signals in response to motion of augmented-reality system 700 and may be located on substantially any portion of frame 710. Sensor 740 may represent one or more of a variety of different sensing mechanisms, such as a position sensor, an inertial measurement unit (IMU), a depth camera assembly, a structured light emitter and/or detector, or any combination thereof. In some embodiments, augmented-reality system 700 may or may not include sensor 740 or may include more than one sensor. In embodiments in which sensor 740 includes an IMU, the IMU may generate calibration data based on measurement signals from sensor 740. Examples of sensor 740 may include, without limitation, accelerometers, gyroscopes, magnetometers, other suitable types of sensors that detect motion, sensors used for error correction of the IMU, or some combination thereof.

In some examples, augmented-reality system 700 may also include a microphone array with a plurality of acoustic transducers 720(A)-720(J), referred to collectively as acoustic transducers 720. Acoustic transducers 720 may represent transducers that detect air pressure variations induced by sound waves. Each acoustic transducer 720 may be configured to detect sound and convert the detected sound into an electronic format (e.g., an analog or digital format). The microphone array in FIG. 7 may include, for example, ten acoustic transducers: 720(A) and 720(B), which may be designed to be placed inside a corresponding ear of the user, acoustic transducers 720(C), 720(D), 720(E), 720(F), 720(G), and 720(H), which may be positioned at various locations on frame 710, and/or acoustic transducers 720(l) and 720(J), which may be positioned on a corresponding neckband 705.

In some embodiments, one or more of acoustic transducers 720(A)-(J) may be used as output transducers (e.g., speakers). For example, acoustic transducers 720(A) and/or 720(B) may be earbuds or any other suitable type of headphone or speaker.

The configuration of acoustic transducers 720 of the microphone array may vary. While augmented-reality system 700 is shown in FIG. 7 as having ten acoustic transducers 720, the number of acoustic transducers 720 may be greater or less than ten. In some embodiments, using higher numbers of acoustic transducers 720 may increase the amount of audio information collected and/or the sensitivity and accuracy of the audio information. In contrast, using a lower number of acoustic transducers 720 may decrease the computing power required by an associated controller 750 to process the collected audio information. In addition, the position of each acoustic transducer 720 of the microphone array may vary. For example, the position of an acoustic transducer 720 may include a defined position on the user, a defined coordinate on frame 710, an orientation associated with each acoustic transducer 720, or some combination thereof.

Acoustic transducers 720(A) and 720(B) may be positioned on different parts of the user's ear, such as behind the pinna, behind the tragus, and/or within the auricle or fossa. Or, there may be additional acoustic transducers 720 on or surrounding the ear in addition to acoustic transducers 720 inside the ear canal. Having an acoustic transducer 720 positioned next to an ear canal of a user may enable the microphone array to collect information on how sounds arrive at the ear canal. By positioning at least two of acoustic transducers 720 on either side of a user's head (e.g., as binaural microphones), augmented-reality device 700 may simulate binaural hearing and capture a 3D stereo sound field around about a user's head. In some embodiments, acoustic transducers 720(A) and 720(B) may be connected to augmented-reality system 700 via a wired connection 730, and in other embodiments acoustic transducers 720(A) and 720(B) may be connected to augmented-reality system 700 via a wireless connection (e.g., a BLUETOOTH connection). In still other embodiments, acoustic transducers 720(A) and 720(B) may not be used at all in conjunction with augmented reality system 700.

Acoustic transducers 720 on frame 710 may be positioned in a variety of different ways, including along the length of the temples, across the bridge, above or below display devices 715(A) and 715(B), or some combination thereof. Acoustic transducers 720 may also be oriented such that the microphone array is able to detect sounds in a wide range of directions surrounding the user wearing the augmented-reality system 700. In some embodiments, an optimization process may be performed during manufacturing of augmented-reality system 700 to determine relative positioning of each acoustic transducer 720 in the microphone array.

In some examples, augmented-reality system 700 may include or be connected to an external device (e.g., a paired device), such as neckband 705. Neckband 705 generally represents any type or form of paired device. Thus, the following discussion of neckband 705 may also apply to various other paired devices, such as charging cases, smart watches, smart phones, wrist bands, other wearable devices, hand-held controllers, tablet computers, laptop computers, other external compute devices, etc.

As shown, neckband 705 may be coupled to eyewear device 702 via one or more connectors. The connectors may be wired or wireless and may include electrical and/or non-electrical (e.g., structural) components. In some cases, eyewear device 702 and neckband 705 may operate independently without any wired or wireless connection between them. While FIG. 7 illustrates the components of eyewear device 702 and neckband 705 in example locations on eyewear device 702 and neckband 705, the components may be located elsewhere and/or distributed differently on eyewear device 702 and/or neckband 705. In some embodiments, the components of eyewear device 702 and neckband 705 may be located on one or more additional peripheral devices paired with eyewear device 702, neckband 705, or some combination thereof.

Pairing external devices, such as neckband 705, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 700 may be provided by a paired device or shared between a paired device and an eyewear device, thus reducing the weight, heat profile, and form factor of the eyewear device overall while still retaining desired functionality. For example, neckband 705 may allow components that would otherwise be included on an eyewear device to be included in neckband 705 since users may tolerate a heavier weight load on their shoulders than they would tolerate on their heads. Neckband 705 may also have a larger surface area over which to diffuse and disperse heat to the ambient environment. Thus, neckband 705 may allow for greater battery and computation capacity than might otherwise have been possible on a stand-alone eyewear device. Since weight carried in neckband 705 may be less invasive to a user than weight carried in eyewear device 702, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 705 may be communicatively coupled with eyewear device 702 and/or to other devices. These other devices may provide certain functions (e.g., tracking, localizing, depth mapping, processing, storage, etc.) to augmented-reality system 700. In the embodiment of FIG. 7, neckband 705 may include two acoustic transducers (e.g., 720(l) and 720(J)) that are part of the microphone array (or potentially form their own microphone subarray). Neckband 705 may also include a controller 725 and a power source 735.

Acoustic transducers 720(1) and 720(J) of neckband 705 may be configured to detect sound and convert the detected sound into an electronic format (analog or digital). In the embodiment of FIG. 7, acoustic transducers 720(l) and 720(J) may be positioned on neckband 705, thereby increasing the distance between the neckband acoustic transducers 720(l) and 720(J) and other acoustic transducers 720 positioned on eyewear device 702. In some cases, increasing the distance between acoustic transducers 720 of the microphone array may improve the accuracy of beamforming performed via the microphone array. For example, if a sound is detected by acoustic transducers 720(C) and 720(D) and the distance between acoustic transducers 720(C) and 720(D) is greater than, e.g., the distance between acoustic transducers 720(D) and 720(E), the determined source location of the detected sound may be more accurate than if the sound had been detected by acoustic transducers 720(D) and 720(E).

Controller 725 of neckband 705 may process information generated by the sensors on neckband 705 and/or augmented-reality system 700. For example, controller 725 may process information from the microphone array that describes sounds detected by the microphone array. For each detected sound, controller 725 may perform a direction-of-arrival (DOA) estimation to estimate a direction from which the detected sound arrived at the microphone array. As the microphone array detects sounds, controller 725 may populate an audio data set with the information. In embodiments in which augmented-reality system 700 includes an inertial measurement unit, controller 725 may compute all inertial and spatial calculations from the IMU located on eyewear device 702. A connector may convey information between augmented-reality system 700 and neckband 705 and between augmented-reality system 700 and controller 725. The information may be in the form of optical data, electrical data, wireless data, or any other transmittable data form. Moving the processing of information generated by augmented-reality system 700 to neckband 705 may reduce weight and heat in eyewear device 702, making it more comfortable to the user.

Power source 735 in neckband 705 may provide power to eyewear device 702 and/or to neckband 705. Power source 735 may include, without limitation, lithium ion batteries, lithium-polymer batteries, primary lithium batteries, alkaline batteries, or any other form of power storage. In some cases, power source 735 may be a wired power source. Including power source 735 on neckband 705 instead of on eyewear device 702 may help better distribute the weight and heat generated by power source 735.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 800 in FIG. 8, that mostly or completely covers a user's field of view. Virtual-reality system 800 may include a front rigid body 802 and a band 804 shaped to fit around a user's head. Virtual-reality system 800 may also include output audio transducers 806(A) and 806(B). Furthermore, while not shown in FIG. 8, front rigid body 802 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 700 and/or virtual-reality system 800 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 700 and/or virtual-reality system 800 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 700 and/or virtual-reality system 800 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 700 and 800 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

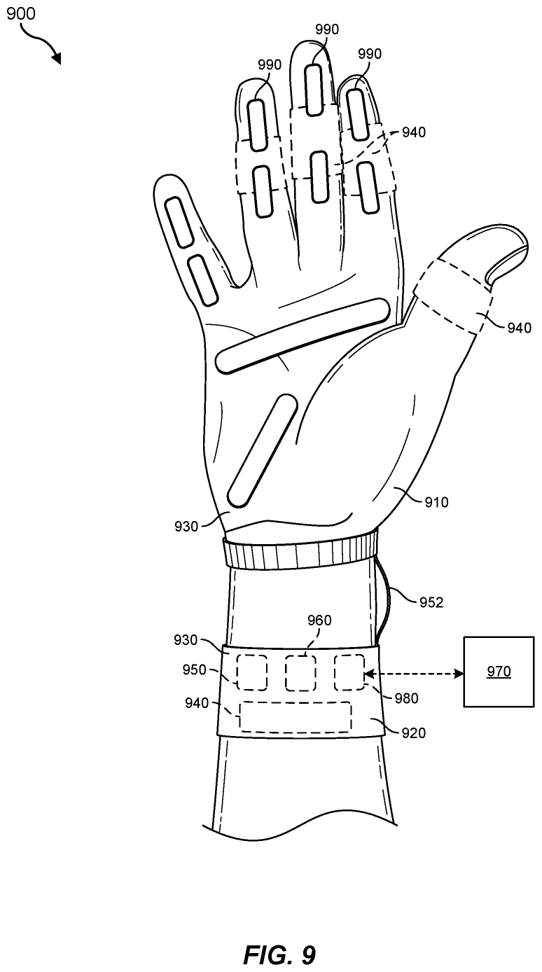

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 9 illustrates a vibrotactile system 900 in the form of a wearable glove (haptic device 910) and wristband (haptic device 920). Haptic device 910 and haptic device 920 are shown as examples of wearable devices that include a flexible, wearable textile material 930 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 940 may be positioned at least partially within one or more corresponding pockets formed in textile material 930 of vibrotactile system 900. Vibrotactile devices 940 may be positioned in locations to provide a vibrating sensation (e.g., haptic feedback) to a user of vibrotactile system 900. For example, vibrotactile devices 940 may be positioned against the user's finger(s), thumb, or wrist, as shown in FIG. 9. Vibrotactile devices 940 may, in some examples, be sufficiently flexible to conform to or bend with the user's corresponding body part(s).

A power source 950 (e.g., a battery) for applying a voltage to the vibrotactile devices 940 for activation thereof may be electrically coupled to vibrotactile devices 940, such as via conductive wiring 952. In some examples, each of vibrotactile devices 940 may be independently electrically coupled to power source 950 for individual activation. In some embodiments, a processor 960 may be operatively coupled to power source 950 and configured (e.g., programmed) to control activation of vibrotactile devices 940.

Vibrotactile system 900 may be implemented in a variety of ways. In some examples, vibrotactile system 900 may be a standalone system with integral subsystems and components for operation independent of other devices and systems. As another example, vibrotactile system 900 may be configured for interaction with another device or system 970. For example, vibrotactile system 900 may, in some examples, include a communications interface 980 for receiving and/or sending signals to the other device or system 970. The other device or system 970 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 980 may enable communications between vibrotactile system 900 and the other device or system 970 via a wireless (e.g., Wi-Fi, BLUETOOTH, cellular, radio, etc.) link or a wired link. If present, communications interface 980 may be in communication with processor 960, such as to provide a signal to processor 960 to activate or deactivate one or more of the vibrotactile devices 940.

Vibrotactile system 900 may optionally include other subsystems and components, such as touch-sensitive pads 990, pressure sensors, motion sensors, position sensors, lighting elements, and/or user interface elements (e.g., an on/off button, a vibration control element, etc.). During use, vibrotactile devices 940 may be configured to be activated for a variety of different reasons, such as in response to the user's interaction with user interface elements, a signal from the motion or position sensors, a signal from the touch-sensitive pads 990, a signal from the pressure sensors, a signal from the other device or system 970, etc.

Although power source 950, processor 960, and communications interface 980 are illustrated in FIG. 9 as being positioned in haptic device 920, the present disclosure is not so limited. For example, one or more of power source 950, processor 960, or communications interface 980 may be positioned within haptic device 910 or within another wearable textile.

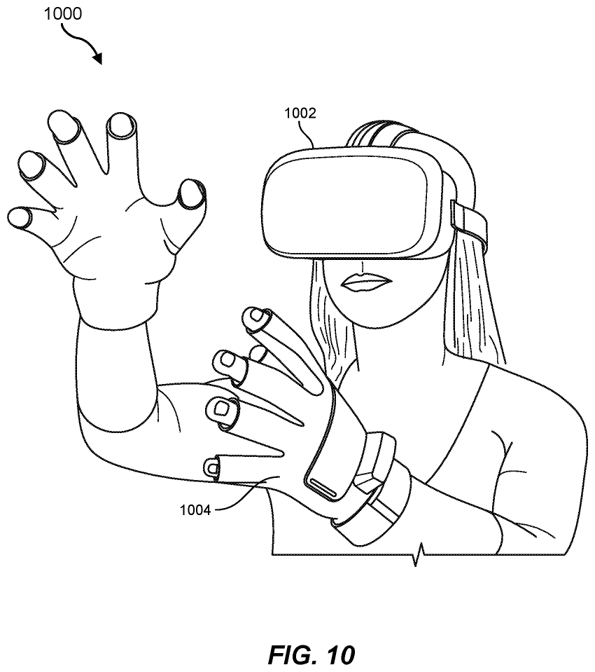

Haptic wearables, such as those shown in and described in connection with FIG. 9, may be implemented in a variety of types of artificial-reality systems and environments. FIG. 10 shows an example artificial-reality environment 1000 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1002 generally represents any type or form of virtual-reality system, such as virtual-reality system 800 in FIG. 8. Haptic device 1004 generally represents any type or form of wearable device, worn by a user of an artificial-reality system, that provides haptic feedback to the user to give the user the perception that he or she is physically engaging with a virtual object. In some embodiments, haptic device 1004 may provide haptic feedback by applying vibration, motion, and/or force to the user. For example, haptic device 1004 may limit or augment a user's movement. To give a specific example, haptic device 1004 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1004 to send action requests to a console. Examples of action requests include, without limitation, requests to start an application and/or end the application and/or requests to perform a particular action within the application.

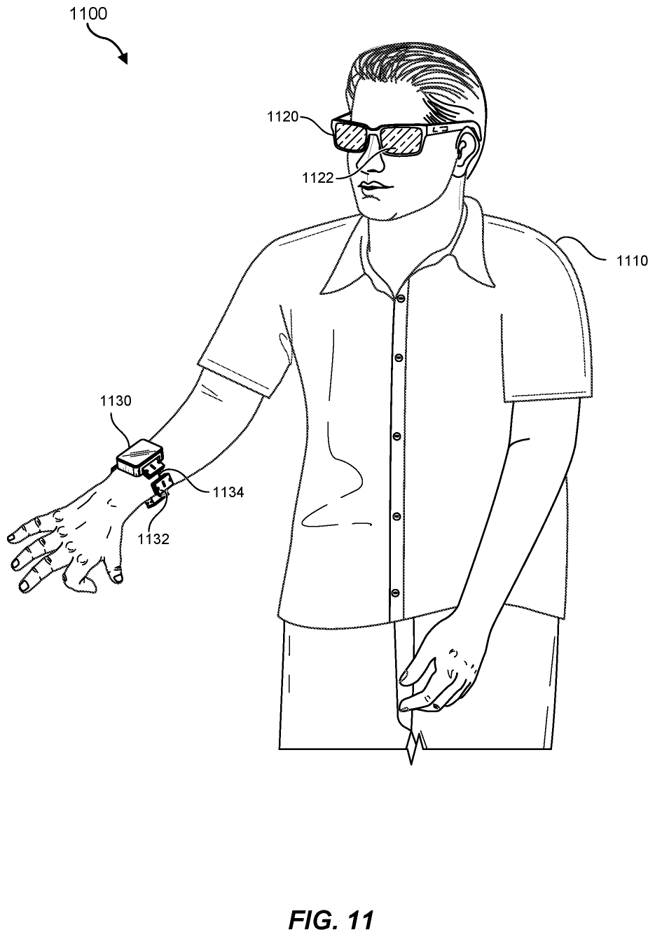

While haptic interfaces may be used with virtual-reality systems, as shown in FIG. 10, haptic interfaces may also be used with augmented-reality systems, as shown in FIG. 11. FIG. 11 is a perspective view of a user 1110 interacting with an augmented-reality system 1100. In this example, user 1110 may wear a pair of augmented-reality glasses 1120 that may have one or more displays 1122 and that are paired with a haptic device 1130. In this example, haptic device 1130 may be a wristband that includes a plurality of band elements 1132 and a tensioning mechanism 1134 that connects band elements 1132 to one another.

One or more of band elements 1132 may include any type or form of actuator suitable for providing haptic feedback. For example, one or more of band elements 1132 may be configured to provide one or more of various types of cutaneous feedback, including vibration, force, traction, texture, and/or temperature. To provide such feedback, band elements 1132 may include one or more of various types of actuators. In one example, each of band elements 1132 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 910, 920, 1004, and 1130 may include any suitable number and/or type of haptic transducer, sensor, and/or feedback mechanism. For example, haptic devices 910, 920, 1004, and 1130 may include one or more mechanical transducers, piezoelectric transducers, and/or fluidic transducers. Haptic devices 910, 920, 1004, and 1130 may also include various combinations of different types and forms of transducers that work together or independently to enhance a user's artificial-reality experience. In one example, each of band elements 1132 of haptic device 1130 may include a vibrotactor (e.g., a vibrotactile actuator) configured to vibrate in unison or independently to provide one or more of various types of haptic sensations to a user.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a lens that comprises or includes polycarbonate include embodiments where a lens consists essentially of polycarbonate and embodiments where a lens consists of polycarbonate.

What is claimed is:

1. A device, comprising:
a pair of electrodes; and
a dynamic material disposed between the pair of electrodes, wherein:
the dynamic material is configured to be in a first state having a first crystalline microstructure when a first electric field is applied between the pair of electrodes;
the dynamic material is configured to be in a second state having a second crystalline microstructure when a second electric field different than the first electric field is applied between the pair of electrodes; and
the dynamic material is configured to scatter light differently in each of the first state and the second state.

2. The device of claim 1, wherein:
the dynamic material comprises a primarily multidomain material in the first state; and
the dynamic material comprises a primarily single domain material in the second state.

3. The device of claim 1, wherein the dynamic material comprises a ferroelectric material.

4. The device of claim 1, wherein the dynamic material comprises at least one of an electroceramic material and a polycrystalline ceramic material.

5. The device of claim 1, wherein the dynamic material comprises lead magnesium niobate-lead titanate (PMN-PT).

6. The device of claim 1, wherein the dynamic material comprises a multidomain material that is configured to undergo microstructural rearrangement between the first state and the second state.

7. The device of claim 6, wherein the microstructural rearrangement results in a change in domain size of multiple crystalline domains in the dynamic material.

8. The device of claim 1, wherein the dynamic material is configured to have a first refractive index in the first state and a second refractive index different than the first refractive index in the second state.

9. The device of claim 1, wherein the dynamic material comprises an electrostrictive material.

10. The device of claim 9, wherein the electrostrictive material comprises a crystalline structure that is oriented to have a polar axis that is substantially parallel to at least one of the first electric field or the second electric field.

11. The device of claim 10, wherein a substantial portion of the electrostrictive material has cubic crystalline structure in at least one of the first state or the second state.

12. The device of claim 10, wherein the electrostrictive material comprises a multidomain material that includes at least one of rhombohedral, monoclinic, or tetragonal domains in at least one of the first state or the second state.

13. The device of claim 10, wherein the polar axis is substantially parallel to the at least one of the first electric field or the second electric field when the electrostrictive material is in a low temperature phase.

14. The device of claim 1, wherein the electrostrictive material is configured to be transparent when it is in at least one of the first state or the second state.

15. A system, comprising:
a light source; and
a speckle mitigation device comprising:
a pair of electrodes; and
a dynamic material disposed between the pair of electrodes and positioned to receive light emitted from the light source, wherein:
the dynamic material is configured to be in a first state having a first crystalline microstructure when a first electric field is applied between the pair of electrodes;
the dynamic material is configured to be in a second state having a second crystalline microstructure when a second electric field different than the first electric field is applied between the pair of electrodes; and
the dynamic material is configured to scatter light received from the light source differently in each of the first state and the second state.

16. The system of claim 15, wherein the light source comprises a laser emitter.

17. The system of claim 15, further comprising a surface positioned to receive light emitted from the light source and passed through the dynamic material of the speckle mitigation device, wherein:
the speckle mitigation device is configured to produce a first speckle pattern on the surface when the dynamic material is in the first state; and
the speckle mitigation device is configured to produce a second speckle pattern on the surface when the dynamic material is in the second state.

18. A method, comprising:
emitting light from a light source toward a dynamic material disposed between a pair of electrodes;
applying a first electric field between the pair of electrodes, wherein the dynamic material assumes a first state having a first crystalline microstructure when the first electric field is applied between the pair of electrodes; and
applying a second electric field different than the first electric field between the pair of electrodes, wherein the dynamic material assumes a second state having a second crystalline microstructure when the second electric field is applied between the pair of electrodes.

19. The system of claim 18, wherein the dynamic material scatters light received from the light source differently in each of the first state and the second state.

20. The system of claim 18, further comprising alternately applying the first electric field and the second electric field between the pair of electrodes multiple additional times, wherein the first electric field and the second electric field are alternately applied at a rate of from approximately 100 Hz to approximately 1000 Hz.
